(19) United States
(12) Patent Application Publication
(10) Pub. No.: US 2006/0221929 A1
(43) Pub. Date: Oct. 5, 2006

(54) Description of packet in a packet communication network

(76) Inventors: Olivier Le Moigne, Ottawa (CA); Olivier Marce, Massy (FR)

Correspondence Address: SUGHRUE MION, PLLC, 2100 PENNSYLVANIA AVENUE, N.W., SUITE 800, WASHINGTON, DC, 20037, US

(21) Appl. No.: 10/563,960

(22) PCT Filed: Jul. 8, 2004
(86) PCT No.: PCT/FR04/01781

§ 371 Date: Apr. 13, 2006

(30) Foreign Application Priority Data
Jul. 11, 2003 (FR) 03/08524

(51) Int. Cl. H04L 12/28

(52) U.S. Cl. 370/351

(57) ABSTRACT

The invention concerns a method for operating a packet communication network node, in particular an IP router, comprising the following steps: a) reception by the node of a packet (10) from the network; b) reception by the node of an information (13) independent of the protocols of the OSI layers 5 through 7 even of the OSI layers 4 through 7 of the packet and concerning at least one of the following characteristics: the type of data transported in the packet, the transmission source of the data transported in the packet other than the network address of the transmission source of the packet, and the recipient of the data transported in the packet other than the network address of the transmission source of the packet; c) processing by the node of the packet (10) on the basis of said description. It is advantageous that said information is contained in the packet itself.

The invention relates to packet communication networks using protocols organized into layers as standardized in the Open System Interconnection (OSI) reference model defined by the International Standards Organization (ISO) or similar thereto. The invention relates more particularly to a method of operating a node of a packet communication network, in particular an IP router. It also relates to a data packet for a packet communication network and a data packet generator for a packet communication network.

Optimizing the transmission of packets in a packet communication network such as an Internet Protocol (IP) network is based on specific processing of the packets at the nodes of the network as a function of their content. In the case of an IP network, the nodes are conventionally called routers.

In particular, quality of service (QoS) mechanisms in networks process different packets sent over the network as a function of parameters such as the sender, the addressee or the type of data contained in the packet. The nodes of the network process the packets as a function of these parameters, for example assigning them a route, a bandwidth, a priority or any other appropriate characteristic. In particular, the quality of service is of primary importance for guaranteeing transmission under good conditions of packets containing voice or video, in particular in the case of Voice over IP and Video over IP transmission.

To be able to manage the streams of packets correctly and efficiently, it is therefore necessary to be able to determine these parameters.

There exist software such as PacketShaper™ from Packeter, Inc. (USA) and processors such as Content Processor 5000™ from LeWiz Communications, Inc. (USA) designed to be used in routers to estimate the type of data contained in a packet. The router estimates the type of data contained in the packet by examining the packets to determine the protocols used in the portions of the packet corresponding to OSI layers 5 to 7 (i.e. layers 5 to 7 of the OSI reference model). The router can in particular determine that the protocol used is the File Transfer Protocol (FTP) or the HyperText Transfer Protocol (HTTP). Then, where appropriate, the router examines the other portions of the packet to determine the type of data contained in the packet, for example by recognizing the signature of an application or a type of data present in the body of the packet (also called the payload). The router assumes that the packet belongs to a predefined processing category as a function of the recognized protocol and the recognized signature, if any. The packet is then classified in the predefined category and the router applies to it the processing corresponding to that category.

The above method has drawbacks, however. Firstly, if a new protocol is used in OSI layers 5 to 7 of a packet, the protocol will not be recognized by a router that has not been updated. The router can therefore no longer assume the content of this kind of data packet. The router can then no longer manage quality of service as a function of the content of a packet in this case. Moreover, the same protocol may be used for different types of data. For example, the HTTP is used both to transport interactive contents and to transfer static files, and can transport information only by means of data that is transported in a sequence of packets (typically a TCP stream), and not by a lone packet. Thus the router cannot determine accurately the type of data as a function only of the transmission protocol used. Moreover, it is not possible to program the router to recognize exhaustively the signatures of all applications or all types of data that may be present in the packet. Moreover, there arises the problem of updating routers with the signatures of new applications or data to a new format. The router is therefore not always able to recognize correctly the type of data contained in a packet. The quality of service is then not the optimum because the different types of data may have different technical requirements.

Another way to provide the parameters useful to the routers would be to use a known signaling protocol adapted to supply information of that type. Using the Session Initiation Protocol (SIP) that is used to send messages containing the type of data transmitted in a stream of packets may therefore be envisaged. This solution has drawbacks, however, as the messages are sent from a sender network element to an addressee network element and are not designed to facilitate their interpretation by routers. In particular, they are transported in a sequence of packets the order of which must, where appropriate, be modified before their content can be interpreted. Moreover, the signaling protocol being different from the protocol for transmitting the data packets described, the probability that the message and the data packets will take different paths is extremely high. Accordingly, the routers through which the data packets pass for the most part do not have access to the description contained in the message. Those routers can therefore not manage the transmission of the data packets in an optimum way.

There is therefore a need for a transmission method that eliminates one or more of the drawbacks cited above.

Thus the invention consists in a method of operating a node of a packet communication network, in particular an IP router, comprising the steps of:

a) the node receiving a packet from the network;

b) the node receiving information independent of the protocols of OSI layers 5 to 7 of the packet and relating to at least one of the following characteristics:
the type of data transported in the packet,
the source of the data transported in the packet other than the network address of the source of the packet, and
the addressee of the data transported in the packet other than the network address of the source of the packet;

c) the node processing the packet as a function of said description.

It is even more advantageous if the information received in the step b) is independent of the protocols of OSI layers 4 to 7 of the packet.

In a preferred embodiment, said information is contained in the packet, the step b) comprising the node reading said information in the packet. Said information may in particular be contained in the header conforming to the protocol of OSI layer 3 of the packet, the step b) comprising the node reading said information in the header conforming to the protocol of OSI layer 3 of the packet.

In another preferred embodiment, the packet contains an identifier of said information, the step a) comprising the node reading the identifier. The identifier may in particular be contained in the header conforming to the protocol of OSI layer 3 of the packet, the step a) comprising the node reading the identifier in the header conforming to the protocol of OSI layer 3 of the packet. Moreover, it is advantageous if the step b) comprises the node receiving another packet from the network, said other packet containing said information. Said information may in particular be contained in the header conforming to the protocol of the OSI layer 3 of said other packet, the step b) then comprising the node reading said information in the header conforming to the protocol of OSI layer 3 of said other packet. Alternatively, said information may be contained in the body conforming to the protocol of OSI layer 3 of said other packet, the step b) then comprising the node reading said information in the body conforming to the protocol of OSI layer 3 of said other packet. It is advantageous if said other packet further contains the identifier, the step b) comprising the node reading the identifier in said other packet. The identifier may in particular be contained in the header conforming to the protocol of OSI layer 3 of said other packet, in which case the step b) comprises the node reading the identifier in the header conforming to the protocol of OSI layer 3 of said other packet. The method may even more advantageously comprise, after the step b), a step of the node sending to a database the identifier and said information.

Another preferred embodiment of the method comprises, after the step a) and before the step b), a step of the node interrogating a database using the identifier.

Another aspect of the invention proposes a packet for a packet communication network comprising information independent of the protocols of the OSI layers 5 to 7 of the packets and relating to at least one of the following characteristics:

the type of data transported in the packet,

the source of the data transported in the packet other than the network address of the source of the packet, and

the addressee of the data transported in the packet other than the network address of the source of the packet.

It is even more advantageous if said information is independent of the protocols of OSI layers 4 to 7 of the packet.

In a preferred embodiment said information is contained in the header conforming to the protocol of OSI layer 3 of the packet. The packet preferably conforms to the Internet Protocol, said information being contained in the Internet Protocol header.

A further aspect of the invention proposes a generator of packets as defined above.

Other features and advantages of the invention will become apparent on reading the following description of embodiments of the invention given by way of example and with reference to the appended drawings, in which:

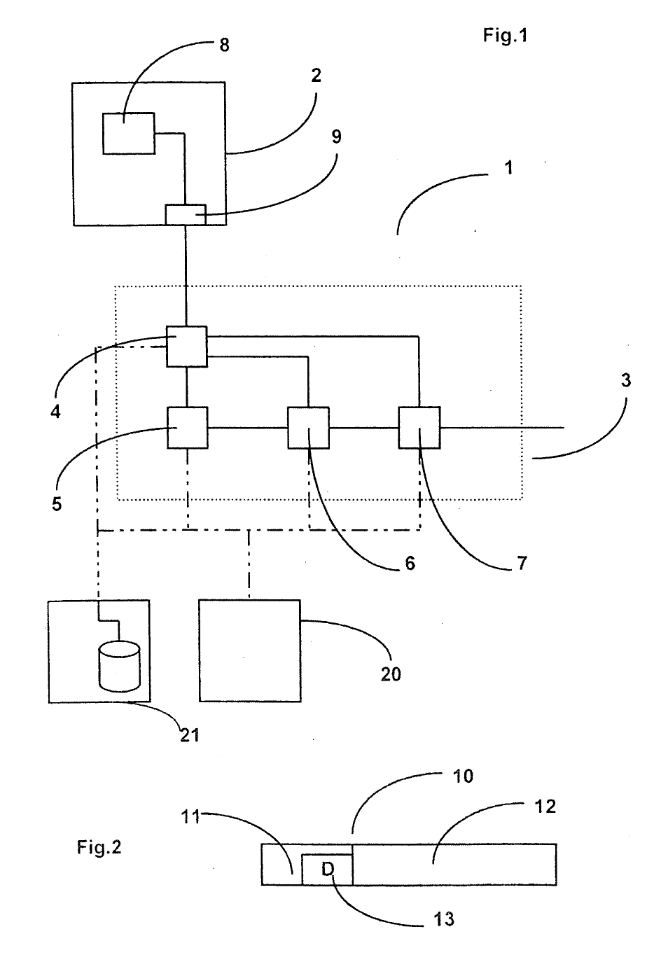

FIG. 1 is a diagram of one example of a transmission network in which the invention is used;

FIG. 2 shows a data packet structure containing a data description;

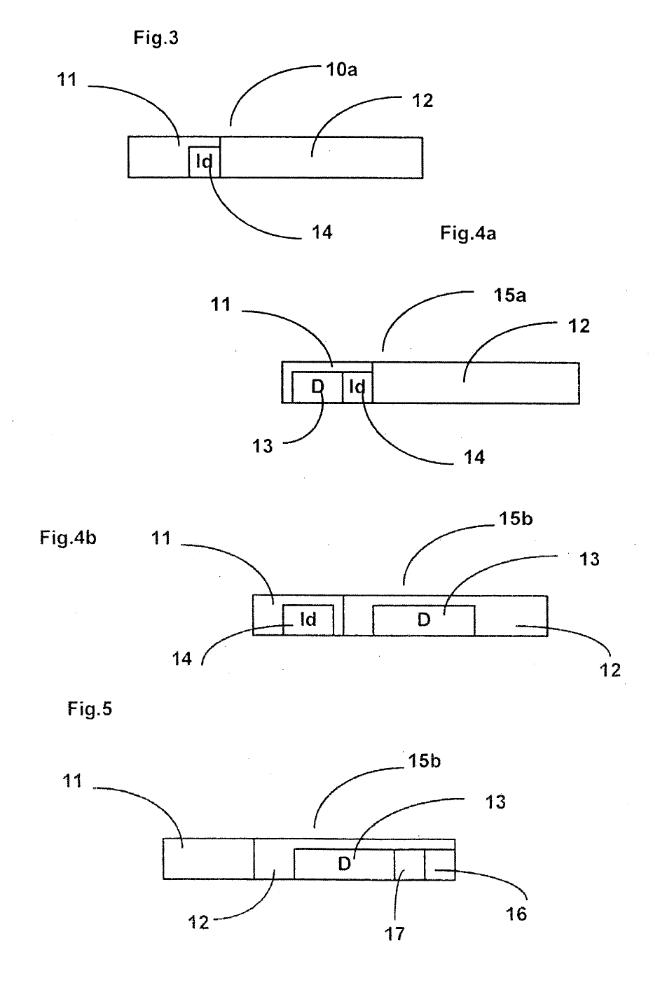

FIG. 3 shows a data packet structure containing a data description identifier;

FIG. 4a shows a data packet structure containing a data description identifier and a data description in the header of the packet;

FIG. 4b shows a data packet structure containing a data description identifier in the header of the packet and a data description in the body of the packet;

FIG. 5 shows a data packet structure containing a data description in the body of the packet.

According to the invention, the method of operation of a packet communication network node comprises the following steps:

a) the node receiving a packet from the network;

b) the node receiving information independent of the protocols of OSI layers 5 to 7 of the packet and relating to at least one of the following characteristics:
the type of data transported in the packet,
the source of the data transported in the packet other than the network address of the source of the packet, and
the addressee of the data transported in the packet other than the network address of the source of the packet;

c) the node processing the packet as a function of said description.

It will be understood that the order in time of the steps a) and b) is immaterial. In other words, the step a) may follow or precede the step b). The steps a) and b) may also be concurrent, in particular if said information is contained in the packet itself.

It will be understood that said information may relate to only any one of the characteristics indicated in the step b), to any two of them or to all three of them. They may further include other information relating, for example, to the processing to be applied to the packets by the node.

The fact that said information is supplied to the node therefore enables the latter to process the packet, for example to choose a path in the network, as a function of said information. In other words, the processing of the packet no longer depends only on information conventionally contained in the packet for this purpose, such as the network address of the source of the packet and the network address of the final addressee of the packet.

Because said information is independent of the protocols of the OSI layers 5 to 7 used in the packet, the node can read and understand said information without knowing those protocols. In other words, the node is capable of processing the packet as a function of said information without knowing the layer 5 to 7 protocols. It is even more advantageous for said information to be independent of the protocol of the OSI layer 4 used in the packet, which enables the node to process the packet as a function of that information independently of that protocol. A network node may not be able to analyze the corresponding layer of the packets that it receives or it is not desirable that it should be able to do so, for reasons of processing speed.

Said information is advantageously written in a code or language that the node is able to understand. That code or language may always be the same one, regardless of the packet concerned.

Said information can preferably be included in the packet itself. This provides a simple and reliable way to get said information to the node of the network in order to process the corresponding data packet. Said information is advantageously contained completely in the packet to which the information relates, as this is a simple way to assure that the node always receives said information for each of the packets. If, on the other hand, said information were divided between a plurality of packets, the node would have to reconstitute it from the plurality of packets after placing them in the appropriate order, which would make the operation more complex. Moreover, the node might be unable to reconstitute the information if it did not receive one of the packets, for example in the event of a change of routing path in the network.

Given that the data sent from a sender terminal to an addressee terminal in a network is generally transported in a stream consisting of many packets each containing the same type of data, for example audio data, each packet may simply contain—in place of said information—an identifier of said information, the identifier being independent of the protocols of the OSI layers 5 to 7, or even of the OSI layers 4 to 7, used in the packet. The node then determines said information that corresponds to the identifier in order to process each packet as a function of said information. Said information may be supplied to the node by various means, for example in a packet or by having it consult a database.

The invention is particularly adapted to be used in an IP network (the Internet Protocol corresponds to OSI layer 3). An IP network is typically organized in four layers: the Internet Protocol or IP layer corresponds to OSI layer 3, the transport layer (typically using the TCP or UDP as its protocol) corresponds to OSI layer 4, and the application layer corresponds to OSI layers 5 to 7.

FIG. 1 is a diagram of one example of a packet communication network 1, in this instance an IP network. The network 1 comprises a terminal 2 sending data packets via a subnetwork 3 to a final addressee, not shown. Hereinafter the expression “payload data” used in respect of a packet refers to the data transported in that packet that is to be transmitted to the final addressee of the packet, either as it stands or where applicable after modification (if the network processes the data transported).

The subnetwork 3 includes routers 4 to 7 supplying a plurality of routing paths for the data packets via the subnetwork 3.

The terminal 2 comprises a data packet generator 8 that can be of any type known in the art, for example a software application for Voice or Video over IP transmission. The generator 8 generates IP data packets that are sent to the final addressee via the subnetwork 3 using an appropriate interface 9 of the terminal 2.

To assure correct processing of a packet sent by the generator 8, it is desirable for the router that receives the packet to have access to information regarding the payload data transported, its source and its destination. To this end, the router is sent the relevant information to enable it to process the packet appropriately. Hereinafter, there is considered by way of example supplying the router with information concerning the transported data that is referred to for convenience as a data description.

In a first embodiment, that data description is placed in the packet transporting the data. In particular, it is advantageous for the data description to be placed in the IP header of that packet, as shown in FIG. 2.

FIG. 2 shows the structure of a packet 10 comprising an IP header 11 and a body 12 (commonly referred to as the “payload”). The header 11 comprises a description 13 of the payload data contained in the body 12 of the packet. The body 12 contains the payload data to be transmitted to the final addressee of the packet, which may be to the format of a protocol of an OSI layer above the IP layer, the latter protocol being a protocol corresponding to OSI layer 3. In particular, the body 12 may conventionally contain a header of a protocol corresponding to OSI layer 4 (transport layer) such as the Transmission Control Protocol (TCP) or the User Datagram Protocol (UDP) encapsulating the payload data to be transmitted to the addressee of the packet. The data is to the format of a protocol of the application layer of the IP reference model that corresponds to OSI layers 5 to 7, as indicated above. That data may be Voice over IP or Video over IP data, for example.

The routers 4 to 7 are designed to read the data description 13 placed in the IP header 11 of the packets that they receive and to process each packet as a function of the description 13 containing in its IP header.

The fact that the data description 13 is placed in the IP header of the packet 10 is advantageous since the router can read it simply by analyzing the IP header 11 of the packet. Now, a router is conventionally able to analyze IP headers. On the other hand, it does not need to process the body 12 of the packet. Thus the router does not need to know the protocol or protocols of OSI layers 4 to 7 that may be used in the body 12 of the packet. This avoids the router having to process the data in the body 12 of the packet and in particular the transported payload data, the router not being intended to effect that type of processing. Moreover, the router is able to process the data description 13 regardless of the protocol or protocols of OSI layers 4 to 7 used in the body 12 of the packet. Finally, the complete description 13 being contained in the packet to be processed, the router does not need to reconstitute the description beforehand by reading a plurality of different packets whose order it has to modify before being able to process a packet as a function of the data description.

This embodiment is particularly adapted for use with IPv6 packets as this type of packet has a header 11 of sufficient size to include a data description. In this case, the data description 13 may in particular be placed in an extension header of the IPv6 header, for example a “Hop-By-Hop Options” extension header.

However, this embodiment may equally be used with IPv4 packets, for example, by writing the data description 13 into an option of the header 11.

Moreover, it is advantageous to have information in the header 11 of the packet indicating to the router that it contains a data description. This may in particular be a predetermined marker in the IP header. Under IPv6, in the cited situation in which the data description 13 is placed in a header extension, a predetermined code may be placed in the header extension immediately after its own header, for example. Under IPv4, in the cited situation in which the data description 13 is placed in a header option, it may in particular be the byte coding the option type.

Regarding the processing to be effected by a given router as a function of the data description 13, the router may be configured by a routing manager 20 also known as a Policy Decision Point (PDP), for example via the IP network itself.

Of course, a router that is not intended to interpret the data description 13 may confine itself to processing—in particular routing—the packet 10 conventionally without taking account of the description 13.

In this first embodiment, each packet 10 is processed by the routers as a function of the data description 13 that is placed in the packet.

In a second embodiment, an identifier of the data description is placed in the IP packet sent by the terminal 2. To be more precise, an identifier placed in a data packet therefore corresponds to a description of the payload data transported in the packet containing that identifier. Once again, the identifier may advantageously be included in the IP header of the packet. FIG. 3 shows the structure of a packet 10a of this kind with an identifier 14 of the data description that is placed in the IP header 11, the body (or payload) of the packet carrying the reference number 12.

Under IPv6 or IPv4, the identifier may be placed in a header extension or a header option, respectively, in a similar way to that described for the data 13 in the first embodiment, for example.

Moreover, it is advantageous to have information in the header 11 of the packet indicating to the router that it contains an identifier 14. Under IPv4 or IPv6, this may be effected in a similar way to the examples given for indicating the presence of the data description 13 in the first embodiment.

The routers 4 to 7 can be adapted to read the identifier 14 in the IP headers 11 of the packets that they receive and to determine the data description that corresponds to the identifier 14. The router then processes the packet as a function of the data description corresponding to the identifier 14 contained in its IP header 11.

This embodiment is advantageous compared to the previous one in that the identifier 14 can be smaller in comparison to the data description, which therefore leaves more room available in the packets for the payload data to be transported.

There are various ways to make the data description correspond to an identifier 14 available to a router.

One advantageous way is to send over the network an IP packet containing both the identifier 14 and the data description corresponding to the identifier 14. That packet is preferably sent along the path across the network that will subsequently be taken by the packets 10a containing the identifier 14 in the data description. Thus the data description is made available to the routers concerned by the stream of packets. For example, a packet sent by the terminal 2 to the final addressee therefore contains both the identifier 14 and the data description.

FIG. 4a shows one example of the structure of a packet 15a of this kind, in which the identifier 14 and the data description 13 corresponding to the identifier 14 are both placed in the IP header of the packet 15a. The body 12 of the packet may contain payload data. Under IPv6, the identifier 14 may be placed in a header extension, for example, and the description 13 in another header extension. Alternatively, the identifier 14 and the description 13 may be placed in the same header extension. Under IPv4, the identifier 14 may be placed in a header option, for example, and the description 13 in another header option. Alternatively, the identifier 14 and the description 13 may be placed in the same header option.

FIG. 4b shows another example of the structure of packet 15b of this kind in which the identifier 14 is placed in the IP header 11 and the data description 13 corresponding to the identifier 14 is placed in the body 12 of the packet. The remaining space available in the body 12 of the packet may contain payload data. Under IPv6, the identifier 14 may be placed in a header extension, for example. The description 13 may be placed at a predetermined location in the body 12 of the packet. Under IPv4, the identifier 14 may be placed in a header option, for example. The description 13 may also be placed at a predetermined location in the body 12 of the packet. The FIG. 4b packet structure is particularly adapted to the situation in which the description 13 is too large to fit in the IP header 11.

Moreover, it is advantageous to have information in the header 11 of the packet to inform the router that it contains both an identifier 14 and a description 13. Under IPv4 or IPv6, this can be done in a similar way to the examples given for indicating the presence of the data description 13 in the first embodiment.

If the router receives a packet of the above kind containing both the identifier 14 and the description 13, it reads them. The router can then process the packet 15 as a function of the description 13. Moreover, the router stores the identifier 14 and the corresponding description 13 in memory. Accordingly, if the router subsequently receives packets of type 10a containing the identifier 14, it processes those packets as a function of the description 13 corresponding to the identifier 14 previously placed in memory.

If the data description corresponding to an identifier is made available to the routers by sending an IP packet containing both the identifier 14 and the corresponding data description 13, it is preferable to ensure that the packet concerned takes the same path across the network as the subsequent packets including the identifier 14. In this way, all the routers along the path of the subsequent packets will be able to store the description 13 beforehand. In particular, the routers may be adapted to apply the same routing to all the packets containing the same identifier 14, whether it also contains the description 13 or not. Alternatively, under IPv6, all the packets of that stream of packets are assigned the same “Flow Label” and the routers are adapted always to apply the same routing to any packet having the same “Flow Label”.

A packet containing both the identifier 14 and the description 13 may be sent only once prior to the other packets of the stream of the type 10a including the identifier 14 without the description 13. However, it is more advantageous to send a packet containing both the identifier 14 and the description 13 regularly, for example each time that a certain number of packets of the type 10a have been sent. In this way a router that has inadvertently lost from its memory the data description 13 corresponding to the identifier 14 can replace it. The router preferably updates its memory with the data description 13 for the identifier 14 concerned each time the latter receives this kind of packet.

Furthermore, the router may use the description 13 in its memory for a given identifier 14 only during a predetermined time period starting from reception of the last packet containing both that identifier 14 and that description 13. This time period is preferably made greater than the time between a packet containing both the identifier 14 and the description 13 and the next packet containing both the identifier 14 and the description 13 for the same stream of packets. As a result, it is of no utility to manage the end of the stream of packets—all containing the identifier 14—sent by the terminal 2 to be able subsequently to reassign the identifier to another data description 13, if necessary.

With regard to the second embodiment, another way to make available to a router a data description 13 corresponding to an identifier 14 is to allow the router to access a database 21 that stores the identifiers 14 and the corresponding data descriptions 13. Communication between the router and the database 21 may be effected via the IP network itself, as shown in FIG. 1. Of course, the same database 21 may advantageously be accessible to a plurality of routers, or even to all the routers of the subnetwork 3.

Accordingly, when it receives a packet 10a, the router reads the identifier 14 contained in the packet. It then uses that identifier 14 to interrogate the database 21, which then sends it the corresponding data description 13. The router thereafter processes the packet as a function of the data description 13 supplied by the database 21. Furthermore, the router may hold in memory the identifier 14 and the corresponding description 13. In this case, if the router subsequently receives packets of type 10a containing the same identifier 14, it processes those packets as a function of the corresponding description 13 previously placed in memory. In other words, the router checks if it already has in memory a description 13 associated with the identifier 14 read in the packet and interrogates the database 21 only if the result of that check is negative. Consequently, the processing of the subsequent packets is faster since there is no loss of time linked to interrogating the database 21.

Using the database 21 is advantageous because a router can always find the description 13 for any identifier, even if the path taken by the various packets varies or if the description 13 corresponding to an identifier 14 is accidentally deleted from the memory of the router.

There are various ways to update the database 21. For example, the terminal 2 may send an IP packet containing both the identifier 14 and the corresponding description 13 to the database 21. The database 21 acknowledges reception thereof to the terminal 2 by means of a return message. After receiving the acknowledgement, the terminal 2 sends the IP packets with the payload data and including the identifier 14 to the final addressee.

In a particularly advantageous embodiment, the use of the database 21 is combined with the method described above for making available to the routers the data description corresponding to an identifier 14, which comprises sending over the network an IP packet containing both the identifier 14 and the corresponding data description. All of the description relating to sending a packet containing both an identifier 14 and the corresponding data description 13 for making said description 13 available to the routers is applicable here, subject to the following additional explanations.

If a router receives the above kind of packet containing both the identifier 14 and the corresponding description 13, it reads them. The router sends to the database 21 the identifier 14 and the description 13, which ensures that the database 21 is updated. Also, the router processes this packet as a function of the description 13. Finally, the router may advantageously store in memory the identifier 14 and the corresponding description 13. Accordingly, if the router subsequently receives packets of type 10a containing the identifier 14, it processes those packets as a function of the description 13 corresponding to the identifier 14 previously placed in memory.

However, it can happen that a router does not have in memory the description 13 corresponding to an identifier 14 contained in a packet of type 10a. This may happen because the router has accidentally lost it from its memory or because it did not receive the packet containing both the identifier 14 and the corresponding description 13. This latter situation may arise in particular if the routers change the routing path after sending the packet containing both the identifier 14 and the corresponding description 13. In this case, the router uses the identifier 14 to interrogate the database 21. The database 21 responds by supplying it with the corresponding description 13. The router then processes the packet as a function of the description 13 which has been supplied and places it in memory for processing packets received subsequently having the same identifier 14.

Of course, in a similar way to the first embodiment, a router may be configured by a routing manager 20, also called a Policy Decision Point (PDP), for example via the IP network itself, to define the processing to be effected on a packet 10a by the router as a function of the corresponding data description 13. The database 21 may form part of the routing manager 20.

Moreover, a router that is not adapted to read the identifiers 14 may confine itself to processing—in particular routing—the packet 10a conventionally without taking account of the identifier 14 and the corresponding description 13.

If there is no centralized control of the definition of the identifiers 14 in the network, it is possible for the same identifier 14 to be used simultaneously in the network for different descriptions 13. To avoid confusion, the routers may take account of additional parameters to distinguish between the streams of packets, for example the IP address of the source of the packets.

Whichever embodiment is considered, the data descriptions 13 and/or the identifiers 14 may be placed in the IP packets that the terminal 2 sends by the terminal 2 itself. With this dim in mind, the terminal 2 may comprise a software application cooperating with the packet generator 8 to place the description 13 and/or the identifier 14 therein as a function of the type of packet to be generated. It may also be the packet generator 8 that places the description 13 and/or the identifier 14 in the IP packets.

Alternatively, it is the first router to which the terminal 2 is connected—here the router 4—that adds to the IP packets coming from the terminal the description 13 and/or the identifier 14 as a function of the type of packet to be generated. In this case, the description 13 may be supplied to the first router by the terminal 2 and that router define an identifier 14 that it causes to correspond to the description.

Whichever embodiment is considered, the data description 13 may advantageously define the type of payload data transported in the IP packet or packets concerned, such as the fact that it is audio or video data, or more generally that it is data forming part of a real time data stream or a very large data stream, or that the data is of a kind sent cyclically. The data description may also comprise technical characteristics concerning the data, for example the sampling frequency in the case of audio data.

The routers can then process—in particular route—the IP packets not only as a function of the single IP destination address placed in their header but also as a function of the nature of the payload data transported and those other technical characteristics. In particular, the router may use the most suitable equipment to process the type of data concerned. For example, the router or the equipment connected to it may use the most appropriate algorithm to evaluate the quality of service provided to the end user for the audio stream concerned. For example, the router may select a specific audio stream management map to effect compression on the fly and on demand, in the case of audio data, or to merge audio and video streams, in the case of a conference call over IP.

Moreover, the data description 13 may be complemented—or replaced—by information concerning the source of the data or the destination of the data other than their IP address in the network. For example, this may be the name or the company name of the source and/or the addressee. Consequently, the router can process the packet taking account of that information. In particular, the router can route the packets as a function of routing rules defined for the addressee defined in this way by the data description 13. For example, it may give preference to sending packets transporting an image to one of the machines of the addressee which has a display adapted to display it, independently of the destination IP address specified in the IP header of the packet or packets concerned.

Finally, the data description 13 may further include information concerning the processing to be effected by the routers passed through, in particular information relating to the quality of service (QoS) to be provided. For example, this kind of information might be the bandwidth to be reserved for the data packets. It might also consist of routing parameters, for example a preferred routing path defined by the sender of the data, here the terminal 2.

It is advantageous for the data descriptions 13 placed in the IP packets to be written in XML. This is because a description 13 in XML can be interpreted by most routers, and the XML scheme used for the description may be retrieved via the network, for example from a predetermined address thereof. The scheme may thereafter be interpreted by the router to construct an internal representation of the information contained in the XML document.

For example, a descriptor in XML associated with voice data may be written as follows:

<flow xmlns=“http://www.alcatel.com/Routing/Flow/Voice”>
<source>

<user> Durand </user>

</source>
<destination>

<user> Dupond </user>

</destination>
<sampling> 8kbits </sampling>
<direction> full-duplex </direction>

The above description specifies the content type (“Voice”), the family name of the sender (“Durand”) and that of the addressee (“Dupond”), the sampling rate (“8 kbits”) and the direction of the exchange (“full-duplex”). As a function of the above information, the routers are able to effect appropriate routing, associating with the packets a buffer of sufficient size to absorb the effects of any jitter that may be encountered in the network, or by choosing a route for or a plurality of the packets as a function of the identities of the addressees and the senders. The various fields of the above type of descriptors are preferably standardized.

An identifier 14 associated with the above descriptor may take the form of an alphanumeric code, for example, such as “voice”.

It will be understood that the data descriptions may also be written in a coded form rather than being close to a natural language that is more directly understandable by humans, as is possible with XML.

Of course, the present invention is not limited to the examples and embodiments described and shown, and lends itself to many variants that will be evident to the person skilled in the art. Although there have been described above packets containing a description 13 and/or an identifier 14, it is clear that the invention applies equally to packets with a plurality of descriptions 13 and/or identifiers 14.

Also, the first and second embodiments of the invention described above may be used without the data descriptions 13 or the description identifier 14 being written into the IP header of the packet, and even without the IP header containing any information to indicate that the packet contains a description 13 and/or an identifier 14. For example, FIG. 5 shows one example of the use of the first embodiment in which the description 13 is placed in the body 12 of an IP packet 16 whose IP header 11 is of the conventional type. Here, the body 12 contains at its end a predetermined identification code 16 to indicate to a router receiving the packet that it contains a description 13. The body 12 contains immediately before the identification code 16 a value 17 indicating the length of the description 13 in the packet 16. The description 13 is placed in the body immediately before the value 17. The remainder of the body 12 contains the payload data to be transported. When a router receives an IP packet, it suffices for it to read the end of the packet to verify the presence of the code 12. If the code is present, it then reads the value 17. Thereafter, the router reads the description 13 contiguous with the value 17 in the packet 16 and delimited by the length defined by the value 17. The router then processes the packet as described above. Obviously, the second embodiment can be used in a similar way, with the identifier 14 replacing the description 13 in the body 12. A predetermined specific code 17 may be defined when the body 12 contains both the description 13 and the identifier 14. In this case, the code 17 may be preceded by a value 17 indicating the length of the description 13 in the packet 16, and then another value 17a indicating the length of the identifier 14 in the packet 16, and then of the description 13, and finally of the identifier 14. In this way of using the first and second embodiments, the description 13 and/or the identifier 14 are written in a language independent of the protocols of OSI layers 5 to 7. The routers are therefore able to read the description and the identifier 14 regardless of the protocols of OSI layers 5 to 7.

Although the various embodiments have been described with reference to IP packets, it will be understood that the invention may be used similarly with other protocols of the OSI layer 3 (called the network layer).

The embodiment of the invention using headers at the level of OSI layer 3 is preferred because the nodes are conventionally adapted to route packets using that protocol. However, the invention may also be implemented at the level of the headers of the protocols of OSI layer 4 (called the transport layer) if it is possible to write therein the data description 13 and/or the identifier 14 and the nodes are able to process that protocol, or those protocols if more than one is used in the same network.

With regard to use of the IPv4 protocol, see in particular the document RFC 791.

With regard to use of the IPv6 protocol, see in particular the document RFC 2460.

With regard the OSI reference model, see in particular the ISO standard 7498.

1. Method of operating a node of a packet communication network, in particular an IP router, comprising the steps of:
a) the node receiving a packet (10; 10a) from the network;
b) the node receiving information (13) independent of the protocols of OSI layers 5 to 7 of the packet and relating to at least one of the following characteristics:
the type of data transported in the packet,
the source of the data transported in the packet other than the network address of the source of the packet, and
the addressee of the data transported in the packet other than the network address of the source of the packet;
c) the node processing the packet (10; 10a) as a function of said description.

2. Method according to claim 1, characterized in that the information received in the step b) is independent of the protocols of OSI layers 4 to 7 of the packet.

3. Method according to claim 1, characterized in that said information (13) is contained in the packet (10), the step b) comprising the node reading said information in the packet.

4. Method according to claim 3, characterized in that said information (13) is contained in the header (11) conforming to the protocol of OSI layer 3 of the packet (10), the step b) comprising the node reading said information in the header conforming to the protocol of OSI layer 3 of the packet.

5. Method according to claim 1, characterized in that the packet (10a) contains an identifier (14) of said information, the step a) comprising the node reading the identifier.

6. Method according to claim 5, characterized in that the identifier (14) is contained in the header (11) conforming to the protocol of OSI layer 3 of the packet (10a), the step a) comprising the node reading the identifier in the header conforming to the protocol of OSI layer 3 of the packet.

7. Method according to claim 5, characterized in that the step b) comprises the node receiving another packet (15a; 15b) from the network, said other packet containing said information (13).

8. Method according to claim 7, characterized in that said information (13) is contained in the header (11) conforming to the protocol of the OSI layer 3 of said other packet (15a), the step b) comprising the node reading said information in the header conforming to the protocol of OSI layer 3 of said other packet.

9. Method according to claim 7, characterized in that said information (13) is contained in the body (12) conforming to the protocol of OSI layer 3 of said other packet (15b), the step b) comprising the node reading said information in the body conforming to the protocol of OSI layer 3 of said other packet.

10. Method according to claim 7, characterized in that said other packet (15a; 15b) further contains the identifier (14), the step b) comprising the node reading the identifier in said other packet.

11. Method according to claim 10, characterized in that the identifier (14) is contained in the header (11) conforming to the protocol of OSI layer 3 of said other packet (15a; 15b), the step b) comprising the node reading the identifier in the header conforming to the protocol of OSI layer 3 of said other packet.

12. Method according to claim 10, characterized in that it comprises, after the step b), a step of the node sending to a database (21) the identifier (14) and said information.

13. Method according to claim 5, characterized in that it comprises, after the step a) and before the step b), a step of the node interrogating a database (21) using the identifier (14).

14. Data packet (10) for a packet communication network comprising information independent of the protocols of the OSI layers 5 to 7 of the packets and relating to at least one of the following characteristics:
the type of data transported in the packet,
the source of the data transported in the packet other than the network address of the source of the packet, and
the addressee of the data transported in the packet other than the network address of the source of the packet.

15. Data packet according to claim 14, characterized in that said information is independent of the protocols of OSI layers 4 to 7 of the packet.

16. Data packet according to claim 14, characterized in that said information is contained in the header (11) conforming to the protocol of OSI layer 3 of the packet.

17. Data packet according to claim 16, characterized in that the packet conforms to the Internet Protocol, said information being contained in the Internet Protocol header.

18. Generator of packets as defined by claim 14.
